(19) United States
(12) Patent Application Publication
(10) Pub. No.: US 2015/0242396 A1
(43) Pub. Date: Aug. 27, 2015

(54) Translating method for translating a natural-language description into a computer-language description

(71) Applicant: Jun-Huai Su, Taipei City (TW)

(72) Inventor: Jun-Huai Su, Taipei City (TW)

(21) Appl. No.: 14/185,930

(22) Filed: Feb. 21, 2014

(51) Int. Cl. G06F 17/28; G06F 17/27

(52) U.S. Cl. CPC G06F 17/289; G06F 17/2705

(57) ABSTRACT

A translating method for translating a natural-language description into a computer-language description includes composing a natural-language description in a natural-language, and parsing the natural-language description with a parser for translating the natural-language description into a parsed description in a computer-language according to context in the natural-language description and a lookup table.

### BACKGROUND OF THE INVENTION

1. Field of the Invention

The present invention relates to a translating method for translating a natural-language description into a computer-language description, and more particularly, a translating method according to context of the natural-language description.

2. Description of the Prior Art

In the field of programming, most computer-languages (such as C, Java, Ruby and Python) are English-based due to the development history of computer-language. For instance, when coding a program in C language, a programmer needs to write “printf” as an instruction keyword for printing strings or numbers on a screen, and use a structure with keywords “if” and “else” for conditional statements. However, since English is the native language of only 360 million people, there are still around 6.7 billion people in the world cannot speak or write English fluently. Hence, a method supporting program-coding in other languages rather than English should be helpful for those people whose mother tongue is not English.

For this purpose, some computer-languages were developed already in prior art. For example, zhpy is a Python-based computer-language which fully supports the use of Chinese keywords, parameters and variables. The following statement (a) is a very short statement coded in zhpy language as an example:

in ‘Hello, world.’ (a)

and the following statement (b) is a statement which is coded in Python language and corresponding to statement (a):

print ‘Hello, world.’ (b)

Except that the used instruction keyword “print” is in English while another keyword “in” is in traditional Chinese, statement (a) (coded in zhpy) is completely equivalent to statement (b) (coded in Python). When compiling statements coded in zhpy, an interpreter module translates zhpy code directly into standard Python code. In this way, a programmer who uses Chinese language more proficiently than English language is allowed to write programs in zhpy rather than in English-based Python, and this will help a Chinese programmer write computer programs with great ease.

Some other computer-languages also allow programmers to write a program in other languages rather than English, for another example, E-LANGUAGE (appeared in 2000 and designed by Wu Tao) , which is a JAVA-like computer-language, is also a computer-language allowing programmers to write a program with Chinese instruction keywords and variables.

Although computer-languages such as zhpy and E-LANGUAGE allow programmers to write a program with Chinese instruction keywords, the structures of the program statements composed in computer-languages such as zhpy and E-LANGUAGE are still very similar to the program structures in a traditional computer language, and this makes the program quite unreadable, especially for beginners of programming. For example, the following table a is a computer-language description composed in zhpy and its corresponding description composed in Python:

TABLE α

| A program description in zhpy | |
|---|---|
| (modified in traditional | A corresponding program |
| Taiwanese version): | description composed in Python: |
| #!/usr/bin/env zhpy | #!/usr/bin/env python |
| # tong-an mia : while.py | # File name: while.py |
| soo-jī = 23 | number = 23 |
| un-hing = tsin | running = True |
| tng un-hing: | while running: |
| tshai-siong = tsing-soo (su-jip | guess = int(raw_input |
| (′su-jip | (′Enter an integer: ′)) |
| chit-e soo-jī: ′)) | |
| ju-ko tshai-siong == soo-jī: | if guess == number: |

| | |
|---|---|
| in ′kiong-hi , li ioh tioh ah.′ | print ′Congratulations, you |

| | |
|---|---|
| un-hing = ke | guessed it.′ |

| | |
|---|---|
| # Tse e su sun-khuan biau-sut kiat-sok. | running = False |

| | |
|---|---|
| | # this causes the while loop to |
| | stop. |
| ka-su tshai-siong < soo-ji: | elif guess < number: |

| | |
|---|---|
| in ′m-tioh , soo-ji koh tua | print ′No, it is higher than |

| | |
|---|---|
| chit-sut-a .′ | that.′ |

| na-bo : | | else: |
|---|---|---|
| | in ′m-tioh, soo-ji koh | print ′No, it is lower than that.′ |
| kiam sio-khoa.′ | | |
| na-bo: | | else: |
| | in ′sun-khuan biau-sut | print ′The while loop is over′ |

| | |
|---|---|
| kiat-sok.′ | print ′Done′ |
| in ′kiat-sok′ | |

Note:
Each of the printed sentences in Chinese shown in the upper-left column is corresponding to a printed sentence in the upper-right column:
“su-jip chit-e soo-ji” means “Enter an integer”;
“kiong-hi, li ioh tioh ah.” means “Congratulations, you guessed it”;
“m-tioh, soo-jī koh tua chit-sut-a” means “No, it is higher than that”;
“m-tioh, soo-ji koh kiam sio-khoa.” means “No, it is lower than that”;
“sun-khuan biau-sut kiat-sok” means “The while loop is over”; and
“kiat-sok” means “Done”.

In the upper-left column of the above table α, it can be seen that although each of these Chinese words: “tong-an mia” (filename), “soo-ji ” (number), “un-hing” (running), “tsin” (true), “tng” (while), “tshai-siong” (guess), “tsing-soo” (integer), “su-jip” (raw_input), “ju-ko” (if), “ka-su” (elif), “in” (print), “na-bo” (else) can be used as a legal keyword, the structure of the composed description still looks very similar to structure of a description of computer-language and quite different from the nature language. Consequently, for program-coding beginners whose native language is not English, the mentioned new-developed computer-languages supporting keywords of other languages rather than English are still not so easy to learn and comprehend.

### SUMMARY OF THE INVENTION

An embodiment of the present invention discloses a translating method for translating a natural-language description into a computer-language description. The method comprises composing a natural-language description in a natural-language; and parsing the natural-language description with a parser for translating the natural-language description into a parsed description in a computer-language according to context in the natural-language description and a lookup table.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a block diagram according to an embodiment of the present invention.

FIG. 2 illustrates a process of translating a series of natural-language words into a computer-language description.

FIG. 3 illustrates a flow chart according to an embodiment of the present invention.

### DETAILED DESCRIPTION

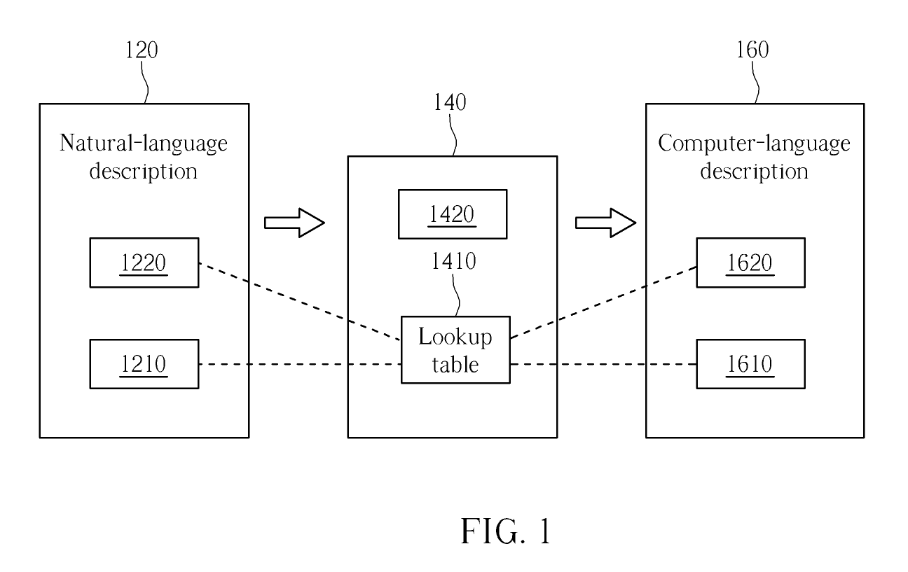

Please refer to FIG. 1. FIG. 1 is an illustration of a block diagram according to an embodiment of the present invention. A natural-language description 120 is composed by a programmer manually in a natural-language. The natural-language description 120 is allowed to be composed on a text-editor or a hardware device. The natural-language maybe Chinese language, English language, Japanese language, Korean language or classical Chinese language. Chinese language is used as an example in the following text. According to an embodiment of the present invention, the natural-language description 120 contains at least one “word”. For example, each Chinese character can be a “word” of the natural-language, and a plurality of words can be combined as a phrase of the natural-language. A word may be a Chinese character, a Japanese character (Kanji or Kana), a Korean character (Hanja or Hangul) or just an English word. The types of a natural-language word may be verbs, nouns, pronouns, adverbs, adjectives, prepositions, conjunctions, or interjections. In a natural-language, a word or a phrase (made of a group of words) is the minimal meaningful unit, and can correspond to a minimal meaningful unit of a computer-language.

The minimal meaningful unit of a computer-language is also known as a “lexeme” or “token” of the computer-language. For example, in a computer-language such as C languages, there are at least six types of tokens:

| | |
|---|---|
| 1. Keywords | (e.g. int, while); |
| 2. Identifiers | (e.g. main, total); |
| 3. Constants | (e.g. 10, 20); |
| 4. Strings | (e.g. “total”, “hello”); |
| 5. Special symbols | (e.g. ( ), { }); and |
| 6. Operators | (e.g. +, /, −, *). |

Token “keyword” and “identifier” are used to define a property of an assigned function or to declare a type of a number or an action. Token “constant” and “string” are used for expressing numbers, printed strings or strings in comments. Token “operator” is used in arithmetic assignments. Token “special symbol” acts as a punctuation mark for a compiler or an interpreter to know where a statement is segmented or finished. All functional instructions, variables, data types, operators, punctuation marks, commands and statements of a computer-language are composed by using at least a set of meaningful lexeme (s) of the computer-language.

In FIG. 1, each word or phrase of natural-language description 120 is analyzed by parser 140 and then translated into a corresponding lexeme, or a corresponding series of lexemes of computer-language description 160. For instance, word 1210 is analyzed and then translated into a set of lexeme (s) , that is statement 1610, and phrase 1220 is analyzed and then translated into another set of lexeme (s) , that is statement 1620. The process taken by parser 140 to perform analysis for identifying meaningful words or phrases (of a natural-language) able to be translated into meaningful statements or commands (of a computer-language) is a parsing process known as tokenization or lexical analysis. Take parser 140 of FIG. 1 for example, parser 140 performs the parsing process by referring to lookup table 1410 and rule manager 1420.

When performing parsing process with parser 140 according to an embodiment of the present invention, parser 140 needs a lookup table for looking up parsed word 1210 or phrase 1220. As shown in FIG. 1, lookup table 1410 is formed in parser 140 for this purpose.

According to another embodiment of the present invention, here is a practical example to demonstrate how to translate a natural-language description into a computer-language description. Please refer to FIG. 1. The following table β is an exemplified part of lookup table 1410:

TABLE β

| Corresponding | Corresponding | Corresponding |
|---|---|---|
| word or | word or | statement |
| phrase | phrase | in C |
| in Taiwanese | in English | language |
| . . . | . . . | . . . |
| ue-hing | draw shape | void DrawShapes( ) |
| | | { |
| | | } |
| ue-goo-kak | draw pentagon | pentagonDraw( ); |
| ue-lak-kak | draw hexagon | hexagonDraw( ); |
| ue-hing ue-goo-kak | draw shape draw | void DrawShapes( ) |
| ue-lak-kak | pentagon draw | { |
| | hexagon | pentagonDraw( ); |
| | | hexagonDraw( ); |
| | | } |
| . . . | . . . | |

According to the above table β, when natural-language description 120 includes a Taiwanese phrase “ue-hing”, parser 140 of the present invention can look up “ue-hing” in look up table 1410 to find out the corresponding statement formed with C language lexeme(s), that is “void DrawShapes( ){ }.

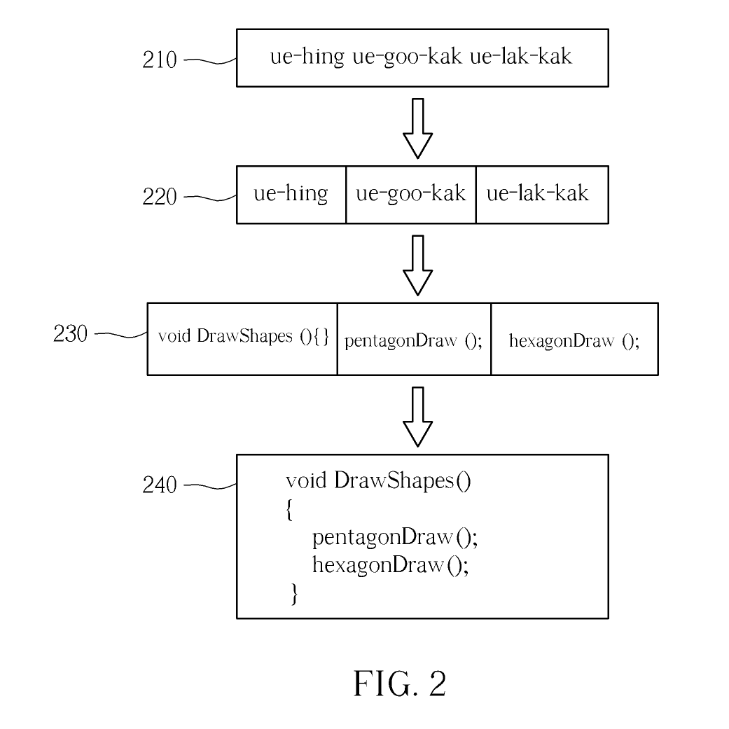

In addition to correlation between natural-language words (or phrases) and computer-language lexemes, a designer of lookup table 1410 is allowed but not limited to make combination rules and store the rules into a rule manager. The rule manager is allowed but not limited to be included in the parser. According to another embodiment of the present invention, a parser designer can make a rule that: when “ue-hing” (corresponding to English words “draw shape”) and “ue*kak” (corresponding to English words: draw triangle, draw rectangle, draw pentagon, or draw hexagon depending on the chosen number in wildcard character “*”) are arranged in series, a nested combination must be taken. Please refer to FIG.2 with FIG.1. When a programmer composes a natural-language description like “ue-hing ue-goo-kak ue-lak-kak”, the parser 140 performs parsing in the following steps:

Step 0: input a natural-language description “ue-hing ue-goo-kak ue-lak-kak” (as shown in block 210), which is composed as a series of Taiwanese characters, into parser 140;

Step 1: separate the series of Taiwanese characters “ue-hing ue-goo-kak ue-lak-kak” into three parts “ue-hing”, “ue-goo-kak” and “ue-lak-kak” (as shown in block 220) by parser 140 according to lookup table 1410 and the above table β (that is apart of lookup table 1410);

Step 2: look up “ue-hing”, “ue-goo-kak” and “ue-lak-kak” respectively in table β and find out corresponding C language statements composed by using C language lexemes, i.e. “void DrawShapes( ){}”, “pentagonDraw( );” and “hexagonDraw( );” (as shown in block 230);

Step 3: take a nested combination and translate natural-language description “ue-hing ue-goo-kak ue-lak-kak” into a computer-language description composed in C-language according to the design rule described above and stored in rule manager 1420 as following:

```
  void DrawShapes ( )
  {
    pentagonDraw ( );
    hexagonDraw ( );
  }
(as shown in block 240).
```

In this way, when a lookup table with enough detailed information and well-designed rules is formed and then consulted by the parser, a programmer is allowed to write natural-language program codes with a coding style and a language structure more similar to natural language, and the programmer no longer needs to code a program with many parentheses, braces and brackets. This is also helpful for the readability of the composed program. The lookup table consulted by the parser can be made according to a statistical analysis and/or a linguistic analysis of the natural-language and the computer-language. According to an embodiment of the present invention, the mentioned lookup table is allowed but not limited to be formed in the parser.

According to another embodiment of the present invention, a natural-language description can be translated into a computer-language description by a parser according to context in the natural-language description, and a lookup table and a rule manager of the parser. That means that a word (or a phrase) is translated into a set of meaningful lexeme(s) of the computer-language according to another word or phrase in the context of the natural-language description. Please refer to the following table γ:

TABLE γ

| Relative keywords in context | hing (Shape) |
|---|---|
| “lak-kak” (hexagon) | statement-01: |
| | hexagonDraw( ); |
| “sann-kak” (triangle) | statement-02: |
| | triangleDraw( ); |
| “inn” (circle) | statement-03: |
| | circleDraw( ); |

Table γ is also a part of a parser such as parser 140 shown in FIG. 1, and table γ is allowed but not limited to be formed in either a lookup table or a rule manager. According to Table γ, when a natural-language word such as Taiwanese character “hing” (“shape” in English) exists in a natural-language description, the corresponding C-language statement (composed by using C-language lexeme) may be one of these three C-language statements: “hexagonDraw( );” (statement-01 of table γ) , “triangleDraw( );” (statement-02 of table γ) and “circleDraw( );” (statement-03 of table γ). However, the parser cannot choose one of these three C-language statements to translate “hing” without more information. Hence, according to an embodiment of the present invention, the parser further scans context of the natural-language description so as to translate Taiwanese word “hing” in this way:
if there exists a keyword “lak-kak” (that means “hexagon”) in the natural-language description, the parser translates “hing” (of Taiwanese) into “hexagonDraw( );” (of C-language) accordingly;
if there exists a keyword “sann-kak” (that means “triangle”) in the natural-language description, the parser translates “hing” (of Taiwanese) into “triangleDraw( );” (of C-language) accordingly; and
if there exists a keyword “Inn” (that means “circle”), the parser translate “hing” (of Taiwanese) into “circleDraw ( ); ” (of C-language) accordingly.

According to yet another embodiment of the present invention, programmer is even allowed to compose a program code in natural language, and then make other people unaware that the composed natural-language program code is actually a program. For example, if the lookup table is written as the following table δ:

TABLE δ

| | Corresponding statement |
|---|---|
| Word or phrase in natural | in computer language (C language) |
| language (classical | composed by using C-language |
| Taiwanese) | lexeme(s) |
| Sann-sian | switch(drawType) |
| (English: “three spirits”) | { |
| | } |
| hok (English: “good fortune”) | case PENTAGON: pentagonDraw |
| | (“This is an English sentence.”); break; |
| lok (English: “prosperity”) | case TRIANGLE: triangleDraw |
| | (“Programmiersprache.com”); break; |
| siu (English: “longevity”) | case CIRCLE: |
| | circleDraw |
| | (“gioksan, ketagalan, biodiversity, |
| | kooting.”); break; |

“Sann-sian hok lok siu” is a popular phrase associated with good luck in classical Taiwanese language, and it means three good spirits bringing good fortune, prosperity and longevity to people. This phrase in classical Taiwanese seems completely unrelated to programming literally. However, if a user modifies a lookup table (consulted by a parser) by referring to table δ, and also adds suitable rules into a rule manager used by the parser to make the parser arrange the translated C-language statements and C-language commands in a nested combination to realize a C-language conditional description, a traditional Taiwanese phrase can hence be parsed and translated as a C-language snippet which controls a computer to draw geometrical shapes. The words “This is an English sentence.” are shown in the drawn pentagon. The words “Programmiersprache.com” are shown in the drawn triangle. The words “gioksan, ketagalan, biodiversity, kooting” (which mean “Mountain Jade, Ketagalan tribe, biodiversity and a place name Kooting ” in Taiwanese languages and English language) are shown in the drawn circle. Therefore, an embodiment disclosed by the present invention is also helpful for the security of a program code.

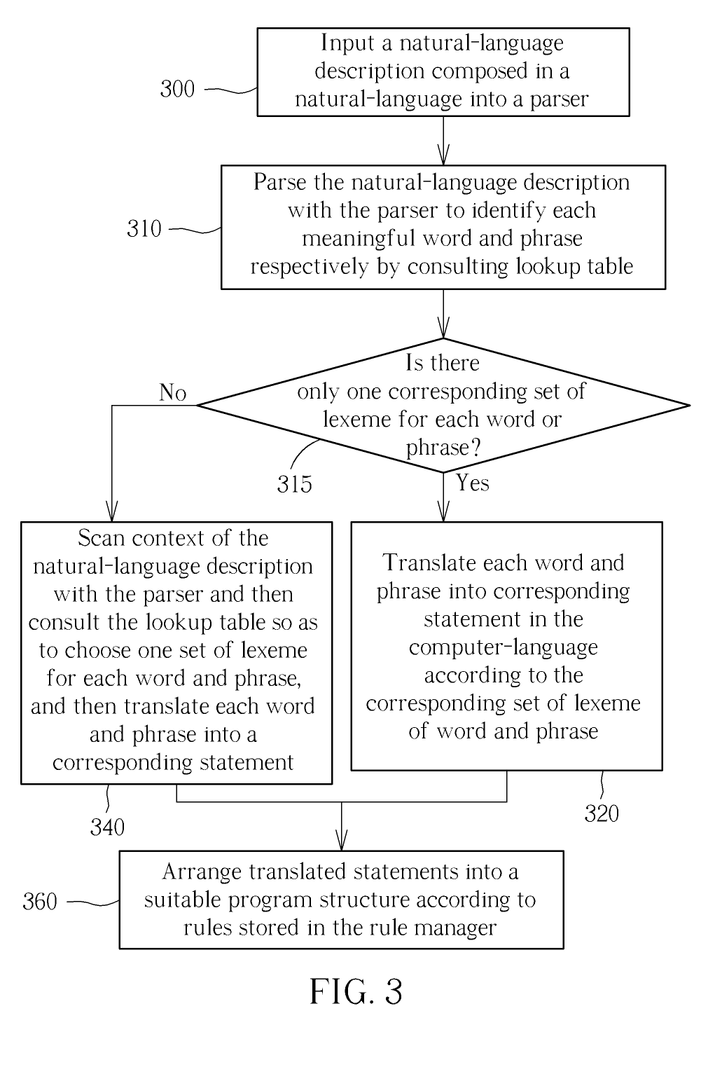

Please refer to FIG.3 with FIG. 1. FIG. 3 is a flow chart according to an embodiment of the present invention. The translating method for translating a natural-language description into a computer-language description disclosed by an embodiment of the present invention can be operated by following the following steps:

Step 300: input a natural-language description 120 composed in a natural-language into parser 140;

Step 310: parse natural-language description 120 with parser 140 to identify meaningful word 1210 and phrase 1220, respectively by consulting lookup table 1410;

Step 315: if there is only one corresponding set of lexeme(s) for each word 1210 or phrase 1220, go to step 320; if there exist more than one corresponding set of lexeme(s) for each word 1210 or phrase 1220, go to step 340;

Step 320: translate word 1210 and phrase 1220 into corresponding statement 1610 and statement 1620 (which are both in computer-language) according to the corresponding set of lexeme(s) for each word 1210 and phrase 1220,; go to step 360;

Step 340: scan context of natural-language description 120 with the parser 140 and then consult lookup table 1410 so as to choose one set of lexeme (s) for each of word 1210 and phrase 1220, and then translate word 1210 and phrase 1220 into corresponding statement 1610 and statement 1620 accordingly (which are both in computer-language); go to step 360;

Step 360: arrange translated statement 1610 and statement 1620 into a suitable program structure according to rules stored in rule manager 1420.

According to an embodiment of the present invention, the mentioned rule manager stores two types of rule.

The first type of rule is combination rule for the parser to combine translated set(s) of lexeme(s) (in a computer-language). For example, the parser follows combination rules stored in the rule manager so as to combine multiple translated computer-language statements as a nested combination or a sequential combination. The mentioned nested combination or sequential combination are examples, and other types of combination are also allowed.

The second type of rule stored in the rule manger is lookup rule for the parser to look up the identified meaningful word(s) or phrase(s) in the lookup table. For example, when performing step 340 mentioned above, after scanning the context of the natural-language description, a suitable set of lexeme(s) (which can be a computer-language statement) is chosen according to a lookup rule stored in the rule manager. Hence, according to an embodiment of the present invention, when a user types a natural-language description on a text-editor, according to the embodiment of the present invention, a corresponding computer-language description is formed in real-time.

According to the above steps disclosed by an embodiment of the present invention, natural-language description 120 is translated into a computer-language description 160. When parsing natural-language description 120 in step 310 to step 340, if there are any parsing errors, parser 140 records the parsing error(s) in a log file, a display, and/or a storage device such as a memory for programmers or an error analyzer to debug. After successfully parsing and translating natural-language description 120 into computer-language description 160, computer-language description 160 is compilable and further inputted into a computer-language compiler to be compiled. According to another embodiment, computer-language description 160 is interpretable and further inputted into a computer-language interpreter to be interpreted.

In summary, with the translating method disclosed by an embodiment of the present invention, it is able to translate a natural-language description having natural-language structure into a compilable or interpretable computer-language description having at least one set of legal and meaningful lexeme(s) satisfying the syntax specification of the computer-language and also a legal computer-language structure. The said “natural language” includes Cantonese language, Chinese language, classical Chinese language, English language, Korean language, Hakka language, Japanese language, Taiwanese language, Vietnamese language, and other natural languages. The said computer-language includes programming language (e.g. C language, Ruby language, Python language, and Java language), markup language (e.g. HTML), scripting language (e.g. JavaScript), functional language (e.g. LISP) and other computer languages.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A translating method for translating a natural-language description into a computer-language description, comprising:
composing a natural-language description in a natural-language; and
parsing the natural-language description with a parser for translating the natural-language description into a parsed description in a computer-language according to context in the natural-language description and a lookup table.

2. The translating method of claim 1, wherein parsing the natural-language description with the parser for translating the natural-language description into the parsed description in the computer-language according to the context in the natural-language description and the lookup table comprises:
utilizing each word or phrase in the natural-language description as an input variable and then looking up the word or phrase in the lookup table with the parser, so as to translate the word or phrase into a set of meaningful lexeme defined in a library of the computer-language.

3. The translating method of claim 2, wherein the set of meaningful lexeme is a functional instruction, a variable, a data type, an operator, a punctuation mark, a keyword or a pointer satisfying a syntax specification of the computer-language.

4. The translating method of claim 2, wherein the lookup table is formed according to a statistical analysis and/or a linguistic analysis of the natural-language and the computer-language.

5. The translating method of claim 1, wherein parsing the natural-language description with the parser for translating the natural-language description into the parsed description in the computer-language according to the context in the natural-language description and the lookup table comprises:
translating a word or phrase into a set of meaningful lexeme of the computer-language according to another word or phrase in the context of the natural-language description.

6. The translating method of claim 5, wherein the set of meaningful lexeme is a functional instruction, a variable, a data type, an operator, a punctuation mark, a keyword or a pointer satisfying a syntax specification of the computer-language.

7. The translating method of claim 5, wherein the lookup table is formed according to a statistical analysis and/or a linguistic analysis of the natural-language and the computer-language.

8. The translating method of claim 1, further comprises:
if the parser generates at least a parsing error when parsing the natural-language description, recording the parsing error in a log file, a display, and/or a storage device.

9. The translating method of claim 1, further comprises:
if the parser generates no parsing error when parsing the natural-language description, inputting the parsed description into a compiler or interpreter corresponding to the computer-language for performing compilation or interpretation.

10. The translating method of claim 1, wherein the natural-language is Cantonese language, Chinese language, classical Chinese language, English language, Korean language, Hakka language, Japanese language, Taiwanese language, Vietnamese language.

11. The translating method of claim 1, wherein the computer-language is C language, Java language, Python language, Ruby language, functional language, markup language, programming language or scripting language, and the parsed description is a compilable or interpretable description composed in the computer-language.
